(19) United States
(12) Patent Application Publication
(10) Pub. No.: US 2020/0058264 A1
(43) Pub. Date: Feb. 20, 2020

(54) Environmental Protection Apparatus

(71) Applicants: John Clinton Smith, Calgary (CA); Davin Lawrence Willetts, Calgary (CA)

(72) Inventors: John Clinton Smith, Calgary (CA); Davin Lawrence Willetts, Calgary (CA)

(21) Appl. No.: 16/103,772

(22) Filed: Aug. 14, 2018

(51) Int. Cl. G09G 5/00; G02B 27/01; A62B 18/04; A62B 18/08

(52) U.S. Cl. CPC G09G 5/006; G02B 27/0172; A62B 18/04; A62B 7/02; G09G 2370/12; G02B 2027/0141; G02B 2027/014; A62B 18/08

(57) ABSTRACT

A breathing apparatus having a face piece having a heads up display (HUD) component. The breathing apparatus further having at least one external sensor for measuring environmental condition data and at least one internal sensor for measuring internal condition data. A control unit is coupled to the at least one external sensor and the at least one internal sensor, and is configured to process the data and provide the data to the heads up display component.

### REFERENCE TO PENDING APPLICATIONS

This application does not claim the benefit of any issued U.S. patent or pending application.

### BACKGROUND OF THE INVENTION

### Field of the Invention

The present invention generally relates to environmental protection apparatus, and in particular to a self-contained breathing apparatus having the ability to send and receive environmental data.

### Background

Rescue workers, firefighters, and other people routinely enter into hazardous environments where smoke, noxious gases, and other dangerous conditions exist. To protect these people, they typically wear a breathing apparatus so that they can perform their duties while not being exposed to the contaminants and other dangerous conditions in the atmosphere.

These breathing apparatus can be a self-contained breathing apparatus (SCBA) having a high-pressure air tank and a pressure regulator or a breathing apparatus having an air line attached to an external air source. With both of these types of apparatus, air is provided to a facepiece.

The prior art breathing apparatus provides some protection from facial and respiratory burns, holds in the cool breathing air as well as provide protection from impact and falling/flying debris. The prior art breathing apparatus typically includes a facepiece lens, an exhalation valve, and a low pressure hose to carry the air from the regulator to the facepiece if the regulator is separate. The facepiece is held at a comfortable distance from the users face due to the rigidity gained by being attached to a helmet portion. The surrounding flesh is protected by a shroud surrounding the remaining face and back of head/neck of the user.

The facepiece lens is made of clear safety plastic and is connected to a flexible rubber mask. The facepiece is held snugly against the face by the head harness with adjustable straps, net, or some other arrangement. The helmet is typically placed on the user's head over the head harness. The facepiece may also have a speech diaphragm to make communication clearer.

In a hazardous or dangerous environment, health and safety is of paramount concern. Having good visibility, reliable communication, and an awareness of the surroundings is critical to the safety of the persons in that environment. Further, head protection is such dangerous and volatile situations is essential.

In the prior art, breathing apparatus have been designed to provide visibility and limited communication. However, there is a need for an improved breathing apparatus that can provide better communication and information to the user thereof.

### BRIEF SUMMARY OF THE INVENTION

The inventive concept is generally relates to environmental protection apparatus, and in particular to a self-contained breathing apparatus having the ability to send and receive environmental data.

In one aspect, a breathing apparatus is disclosed. The breathing apparatus includes a face piece having a heads up display (HUD) component. The face piece may have a scratch resistance lens with screen protector affixed thereto. Further, the lens may have transition/auto tint capabilities.

The breathing apparatus further includes at least one external sensor for measuring environmental condition data and a control unit for processing this data. In some aspects, the external sensors may include a temperature sensor, wind speed sensor and/or wind direction sensors. The control unit processes the measured external data and provides this data to the HUD so that the user may see the external conditions that surround him.

The breathing apparatus further includes at least one internal sensor for measuring internal condition data. In some aspects, the internal sensor may includes an oxygen level sensors to determine the level of oxygen in an oxygen tank that may be attached to the breathing apparatus. The control unit processes the internal data and provides this data to the HUD so that the user may see the internal conditions.

In some aspects, the breathing apparatus may further include a helmet component secured to the face piece and/or a shroud component secured to the helmet and/or face piece. The helmet component and/or shroud component by individual components or may be constructed to form a unified single unit to further isolate the user from the external atmosphere. That is, the helmet and face piece may be a single unit; the face piece and shroud may be a single unit; or the helmet, shroud and face piece may a single unit. The disclosure of the inventive breathing apparatus herein as being individual components is merely illustrative and not limiting.

In some aspects, the breathing apparatus may further include a data input port. This port may be configured to receive a connector, such as an HDMI, USB or other similar type of connector, in order to facilitate the transfer of data.

In some aspects, the control unit may further include a wireless transmission unit configured to transmit and receive communications and data across a wireless communication network. The control unit may also include a GPS tracking module configured to determine location data of the user. This GPS data may be provided to the HUD and/or to third parties over the wireless communication network.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a front view of an embodiment of the present invention.

FIG. 2 is a side view of an embodiment of the bed panel of the present invention.

FIG. 3 is a schematic block diagram of an embodiment of the present invention.

### DETAILED DESCRIPTION OF THE INVENTION

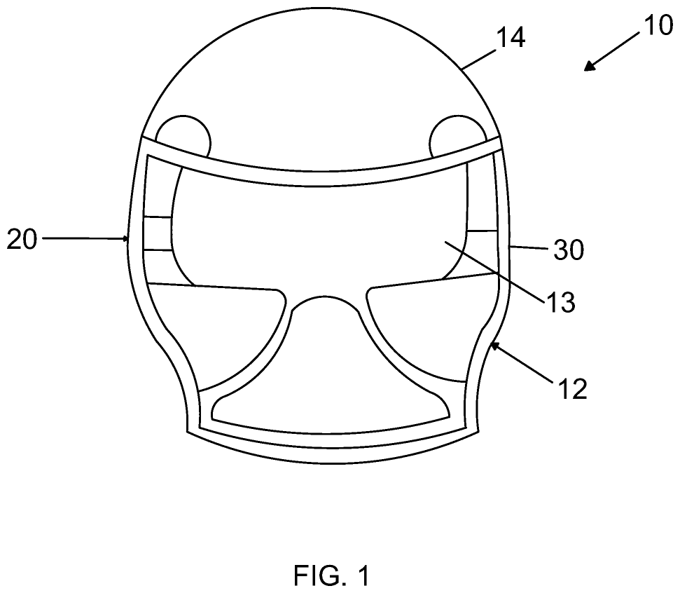

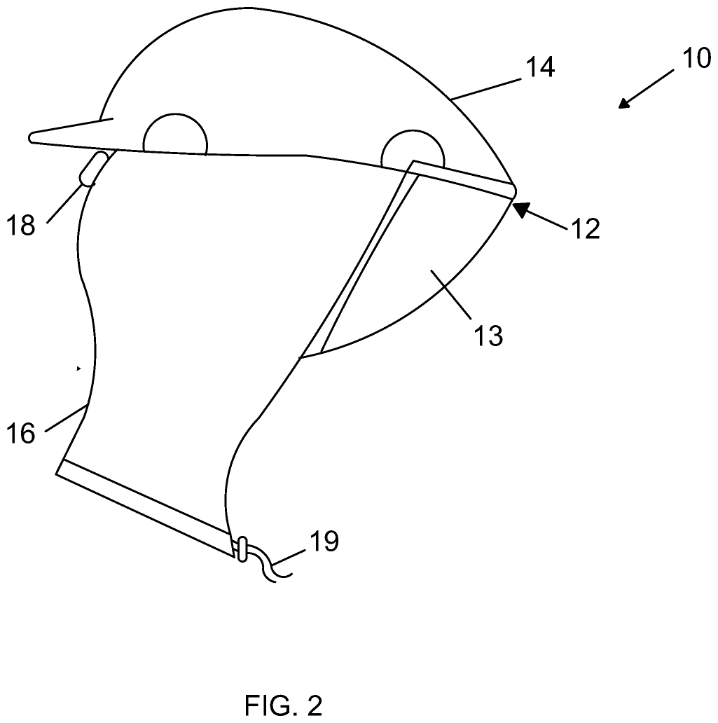

As illustrated in FIGS. 1 and 2, an embodiment of a breathing apparatus 10 is illustrated. Breathing apparatus 10 includes a face piece 12, a hard hat 14, and a shroud 16. In this embodiment, breathing apparatus 10 shown to include a hard hat and a shroud. However, this is illustrative and is not meant to be limiting. Those skilled in the art will recognize that the inventive breathing apparatus may be utilized without a hard hat and/or shroud. Further, this embodiment utilizes the term hardhat. This term may include all forms of protective headgear including hard hats, along with full coverage and partial coverage helmets.

Located within hard hat 14 is a processor and memory configured to received data

Shroud 16 may be constructed of any protective type of material including latex, leather or soft rubber. Further, shroud 16 may include size adjustment components 18 so that shroud 16 may be custom fitted to the user's head. Still further, shroud 16 may include a securing component 19, such as a drawstring, to secure shroud 16 around the users shoulders and neck.

The face piece 12 includes a lens 13 and a heads-up display (HUD) 20. HUD 20 is configured to display external environmental data 22. External environmental data 22 may include data relating to the external environmental conditions that surround the user. This data may include, but is not limited to, external temperature data 24, wind direction data 26, windspeed data 28. By displaying this data 22 on HUD 20, the user will be able to determine any changes to the external environment that could have an impact on the user's relative safety. For example, the external temperature data will inform the user of any changes to the external temperature surrounding that user which could alert the user of a dangerous temperature level.

HUD 20 is further configured to display internal condition data 30. Internal condition data 30 may include data relating to the internal conditions of breathing apparatus 10, such as but not limited to, the oxygen level data 32 of a connected oxygen tank. By displaying this data 30 on HUD 20, the user will be able to determine if any changes to internal conditions may have an impact on the user's relative safety. For example, oxygen level data 32 will inform the user of the amount of oxygen that remains in an attached oxygen tank.

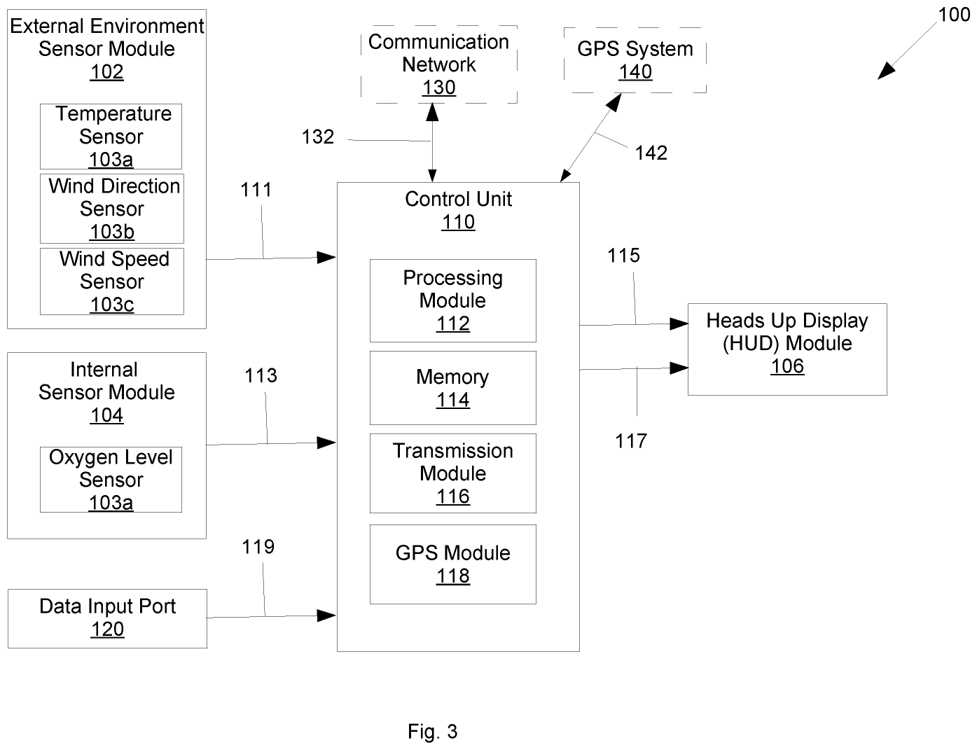

As illustrated in FIG. 3, a block diagram of an embodiment of the breathing apparatus 100 of the present invention is illustrated. Breathing apparatus 100 includes an external environment sensor component 102 in communication with the control unit 110. Also in communication with control unit 110 is an internal condition sensor component 104. Control unit 110 is in communication with the heads-up display (HUD) module 106.

External environment sensor component 102 includes at least one external sensor 103 configured to measure one or more conditions located externally from breathing apparatus 100. The at least one sensor 103 may include, but is not limited to, a temperature sensor 103a, a wind direction sensor 103b, and a wind speed sensor 103c. The measured external condition data 111 obtained by the at least one external sensor 103 is provided to control unit 110 where it is processed. The process external data 115 provided to HUD module 106 where it is displayed for the user's viewing.

Internal condition sensor component 104 includes at least one internal sensor 105 configured to measure one or more conditions within the interior of breathing apparatus 100. The at least one internal sensor 105 may include, but is not limited to, oxygen level sensors 105a that measures the level of oxygen remaining in an attached oxygen tank. The measured internal condition data 113 is provided to control unit 110 where it is processed. The process internal data 117 is provided to module 106 where it is displayed for the user's viewing. Those skilled in the art will recognize that the inclusion of the specific external and internal sensors is merely illustrative and is not meant to be limiting and at other external and internal sensors may be included and are within the scope of the present invention.

An embodiment of control unit 110 include a processing module 112 and memory which 114. Processing module 112 is configured to receive and process sensor data so that such data may be transmitted or otherwise provided to HUD module 106. Memory 114 is configured to store sensor data.

In an additional embodiment, control unit 110 includes a transmitting module 116 is configured to wirelessly transmit and receive communications and data 132 to outside communication networks 130. GPS module 118 is configured to determine the user's location based on signals 142 received from a GPS system 140.

The inclusion of HUD 20 is illustrative of the transfer of information to the user. Other visual and audio apparatus, such but not limited to, an external display that may be located outside of the face mask and audio components mounted inside the hard-hat 14, are within the scope of the present invention.

Regarding the embodiment where an external display is utilized, the external display may in fixed or wireless communication with control unit 110 in order to receive external and internal data 115, 117 respectively. Further, the external display may be removably affixable to the user, e.g. arm, wrist, etc, such that the user may have visual access to the data displayed thereon.

Regarding the embodiment where an audio component is utilized, control unit 110 may include may include speech synthesis hardware and software, such as text-to-speech (TTS), to create a spoken sound version of the external and internal data 115, 117. Earbuds or other similar headphone may be in communication with control unit 110 in order to allow the user listen to the spoken sound version of the data.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A breathing apparatus comprising:
a face piece having a heads up display (HUD) component;
at least one external sensor for measuring environmental condition data;
at least one internal sensor for measuring internal condition data; and
a control unit coupled to the at least one external sensor and the at least one internal sensor, the control unit configured to process the data and provide the data to the heads up display component.

2. The breathing apparatus of claim 1 further comprising a helmet component secured to the face piece.

3. The breathing apparatus of claim 2 further comprising a shroud component secured to the helmet and face piece.

4. The breathing apparatus of claim 1 wherein the at least one external sensor includes a temperature sensor.

5. The breathing apparatus of claim 1 wherein the at least one external sensor includes a wind speed sensor

6. The breathing apparatus of claim 1 wherein the at least one external sensor includes a s a wind direction sensors

7. The breathing apparatus of claim 1 wherein the at least one internal sensor includes an oxygen level sensors to determine the level of oxygen in an oxygen tank.

8. The breathing apparatus of claim 1 further comprising a data input port.

9. The breathing apparatus of claim 8 wherein the data input port is configured to receive data through a HDMI connection.

10. The breathing apparatus of claim 1 further comprising a GPS tracking module configured to determine and provide the location data to the heads up display.

11. The breathing apparatus of claim 1 wherein the control unit further comprises a transmission unit configured to transmit and receive data across a communication network.

12. The breathing apparatus of claim 1 further comprising a GPS tracking module configured to determine and provide the location data to the transmission unit.
